(19) United States
(12) Patent Application Publication
(10) Pub. No.: US 2021/0070601 A1
(43) Pub. Date: Mar. 11, 2021

(54) VALVE ASSEMBLY

(71) Applicant: IPET TECHNOLOGIES, LTD., Nicosia (CY)

(72) Inventor: Constantinos Sideris, Nicosia (CY)

(73) Assignee: IPET TECHNOLOGIES, LTD., Nicosia (CY)

(21) Appl. No.: 17/049,888

(22) PCT Filed: May 3, 2019
(86) PCT No.: PCT/IB2019/053639

§ 371 Date: Oct. 22, 2020

Related U.S. Application Data
(60) Provisional application No. 62/666,434, filed on May 3, 2018.

(51) Int. Cl. B67D 1/12; F16K 17/04; F16K 17/168

(52) U.S. Cl. CPC B67D 1/125; B67D 1/0831; F16K 17/168; F16K 17/04

(57) ABSTRACT

A pressure relief valve assembly may include a housing having an inner lumen, a pin configured to engage the housing, and a spring coupled to the pin. The spring may bias the pin in a closed position relative to the inner lumen of the housing and axially extend when the pin is adjusted from the closed position to an opened position.

### CROSS-REFERENCE TO RELATED APPLICATIONS

This application is a National Stage of International Application Serial No. PCT/IB2019/053639, filed May 3, 2019, which claims the benefit of priority under 35 U.S.C. § 119 of U.S. Provisional Application Ser. No. 62/666,434, filed May 3, 2018, the entirety of which are incorporated herein by reference.

### TECHNICAL FIELD

The disclosure relates generally to pressure valves, and more particularly to pressure valves for relieving pressure within a keg assembly and/or other pressurized containers.

### BACKGROUND

Metal kegs, primarily made of stainless steel, have been used to hold, transport, and dispense fluid for many years. Recently plastics technology, such as injection stretch blow molding, has been applied to the manufacture of kegs out of polymer materials, such as polyethylene terephthalate (PET). A common theme between any type of keg is that the fluid (e.g., a gas and/or liquid) contained within the keg is held under pressure. As pressure within a keg increases, the increased pressure may cause damage to or failure of the keg assembly.

### SUMMARY

There is a current need for simple, compact, and reliable pressure relief valves, particularly for kegs and other pressurized containers. As such, this disclosure pertains to valve assemblies for kegs and other pressurized containers.

Accordingly, a disclosed pressure relief valve assembly may include a housing, a pin, and a spring. The housing may have an inner lumen extending from a first end of the housing to a second end of the housing and the pin may be configured to engage the first end of the housing. The spring may have a first end coupled to the pin and may be configured to bias the pin in a closed position relative to the inner lumen of the housing. When adjusted from the closed position to an opened position, the spring may be configured to extend.

In some instances, an assembly for a keg may be disclosed and include a neck and a valve assembly disposed in the neck. The neck may have an outer surface extending from a top portion to a bottom portion of the neck and define a neck lumen. The valve assembly may include a housing, a pin, and a spring. The housing may have an inner lumen extending from a first end to a second end of the housing and the pin may be configured to couple to the first end of the housing. The spring may have a first end configured to couple to the pin and the spring may be configured to bias the pin in a closed position relative to the inner lumen and axially extend as the pin moves from the closed position to the opened position.

In another instance, a keg assembly may be disclosed and include, a keg body, a hollow extension, and a valve assembly. The keg body may have a neck portion and a hollow interior configured to hold fluid. The hollow extension may be in communication with the hollow interior of the keg body and the valve assembly may be configured to be disposed within the hollow extension. The valve assembly may include a housing, a pin, and a spring. The housing may have an inner lumen extending from a first end to a second end of the housing and the pin may be configured to engage the first end of the housing. The spring may have a first end engaging the pin and a distal end configured to couple to the retainer. The spring may be configured to extend upon transitioning the pin from a closed position to an opened position to decrease the pressure inside the keg body.

The preceding summary is provided to facilitate an understanding of some of the innovative features unique to the present disclosure and is not intended to be a full description. A full appreciation of the disclosure can be gained by taking the entire specification, claims, drawings, and abstract as a whole.

### BRIEF DESCRIPTION OF THE FIGURES

The disclosure may be more completely understood in consideration of the following description in connection with the accompanying drawings, in which:

FIG. 1 is a schematic top perspective view of an illustrative keg assembly;

FIG. 2 is a schematic side view of the illustrative keg assembly of FIG. 1;

FIG. 3 is a schematic cross-sectional view of an illustrative top portion of a keg assembly;

FIG. 4A is a schematic perspective view of an illustrative valve assembly for relieving pressure inside a pressurized container with the valve assembly in a closed configuration;

FIG. 4B is a schematic perspective view of the illustrative valve assembly depicted in FIG. 4A with the valve assembly in an opened configuration;

FIG. 5 is a schematic exploded view of the illustrative valve assembly of FIG. 4A;

FIG. 6 is a schematic perspective view of an illustrative pin for a valve assembly;

FIG. 7 is a schematic side view of the illustrative pin for a valve assembly of FIG. 6;

FIG. 8 is a schematic perspective view of an illustrative retainer for a valve assembly; and

FIG. 9 is a schematic cross-sectional view of the illustrative valve assembly of FIG. 4A in a closed configuration;

FIG. 10 is a schematic cross-sectional view of the illustrative valve assembly of FIG. 4A in a closed configuration, taken along a plane substantially perpendicular to a plane along which the cross-sectional view of FIG. 9 was taken.

FIG. 11 is a schematic cross-sectional view of the illustrative valve assembly of FIG. 4A in an opened configuration, taken along the cross-sectional plane depicted in FIG. 9; and

FIGS. 12A-12E depict schematic side views of an illustrative pin of a valve assembly being manually moved from a closed position to an opened position within a housing, the housing depicted in cross-section.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DESCRIPTION

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used in connection with other embodiments whether or not explicitly described unless clearly stated to the contrary.

The following description should be read with reference to the drawings in which similar structures in different drawings are numbered the same. The drawings, which are not necessarily to scale, depict illustrative embodiments and are not intended to limit the scope of the disclosure.

A relief valve or pressure relief valve may be a type of safety valve used to control or limit the pressure in a system that might otherwise build up and create a process upset or equipment failure. The pressure may be relieved by allowing the pressurized fluid to flow through an auxiliary passage out of the system (e.g., via a relief valve). The relief valve may be designed or set to open at a predetermined set pressure to protect pressurized containers from being subjected to pressures that exceed their design limits. When the set pressure is exceeded, a path through the relief valve may become a path of least resistance and the valve may be forced open by the pressure in the pressurized container and a portion of a pressurized fluid (e.g., a liquid and/or gas) may be expelled through the open relief valve. As a portion of the fluid is expelled, the pressure inside the vessel may return to a level that is not beyond the predetermined set pressure and the relief valve may close. In addition, the relief valve may be configured to be manually opened to expel fluid through the relief valve at a desired time and then closed even if the pressure in the pressurized container has not exceeded a set pressure. Although relief valves or pressure relief valves are described herein with respect to kegs, the disclosed relief valves or pressure relief valves may be used with other pressurized containers.

In some cases, the relief valve may include a spring that is configured to establish the predetermined set pressure at which fluid within the pressurized container may cause the relief valve to open. In such cases, the spring may establish the predetermined pressure by requiring a compression force or an extension force to act on the spring and allow the relief valve to open when a pressure in the pressurized container reaches and/or exceeds the predetermined pressure. However, when a compression force acting on the spring is required to allow the relief valve to open, the spring may be susceptible to buckling as the compression of the spring may not occur along a longitudinal axis of the spring. Buckling of the spring may change a pressure at which the relief valve opens in an unintended or unexpected manner. In such cases, one or more guiding components (e.g., a lumen, axle, and/or other suitable components) may be required on the inside and/or outside of the spring to constrain the spring to move only along its longitudinal axis. On the other hand, when an extension force acting on the spring is required to allow the relief valve to open, the spring is not susceptible to buckling even if a load acting on the spring is not perfectly in-line with a longitudinal axis of the spring. Thus, when an extension force is required to act on the spring, rather than a compression force to open the relief valve, a guiding component may not be required to maintain the operation of the relief valve as intended and expected.

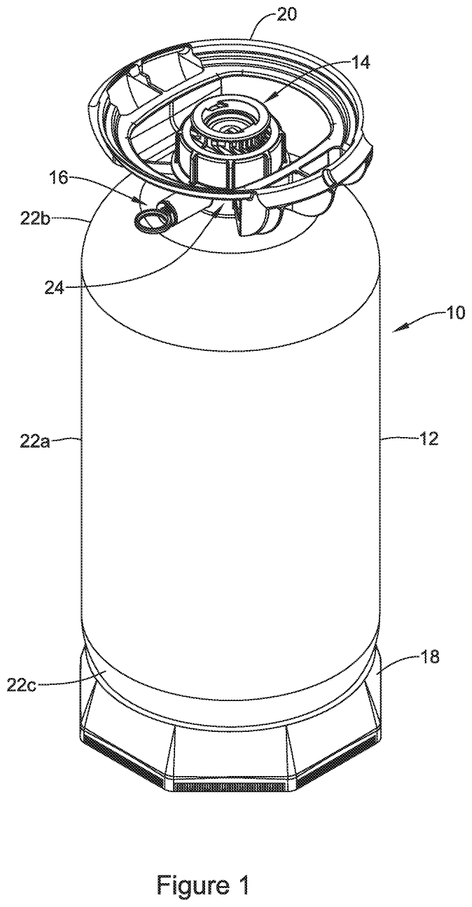

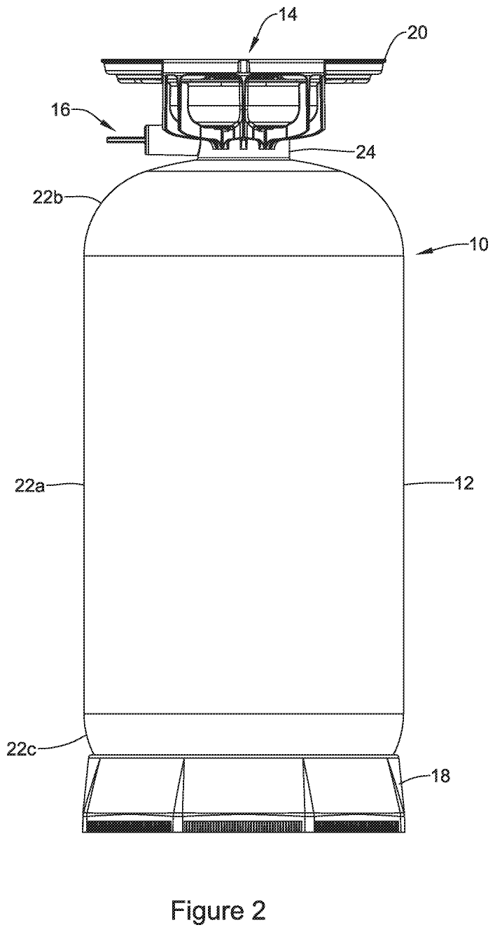

FIGS. 1 and 2 depict an illustrative keg assembly 10, according to embodiments of the present disclosure. FIG. 1 depicts a perspective view of the keg assembly 10 and FIG. 2 depicts a side-view of the keg assembly 10. As shown, the keg assembly 10 may include a keg body 12, a neck assembly 14 including a valve assembly 16, a base 18, and a handle assembly 20. The disclosed keg assembly 10 may be a one-way keg (e.g., a single-use keg) or a reusable keg.

The keg body 12 may be a hollow container that serves as a receptacle to be filled with a fluid (e.g., a gas and/or liquid, such as beer, soda, cider, carbon dioxide, etc.). In one example, the keg body 12 may have a mid-part 22A, an upper-part 22B, and a lower part 22C. In some cases, a neck portion 24 may extend from or stand up from the upper part 22B of the keg body 12 or from suitable other portions of the keg body 12.

The keg body 12 may be formed from a suitable material. In some cases, the keg body 12 may be comprised of a polymer, such as polyethylene terephthalate (PET) material (e.g., a bottle grade PET material or other PET material), a polypropylene (PP) material, a polyethylene (PE) material, a polyethylene naphthalate (PEN) material, and/or other material. In one example, a PEN material, among other materials, may be used for reusable kegs. In addition to or as an alternative to being formed from a polymer, the keg body 12 may be comprised of a different material type, such as stainless steel, aluminum, and/or other metal material. In other instances, the keg body 12 may be comprised of other suitable metal materials, polymer material, composites of two or more material types, materials including fibers (e.g., fiber-reinforced materials), other suitable materials, and/or combinations thereof.

The keg body 12 may be formed in any suitable manner. In some instances, for example when the keg body 12 may be formed with a polymer material and/or in other suitable instances, the keg body 12 may be manufactured by a molding process (e.g., a blow molding process or other molding process). In one example a stretch blow molding process using PET may be utilized, but this is not required and other keg body forming techniques are contemplated.

In some cases, the keg body 12 may be formed in a single layer of material (e.g., a polymer material such as PET and/or other polymer materials). In other cases, the keg body 12 be formed with a multi-layer or laminated construction. Such a multi-layer or laminated construction may improve the shelf life of the keg body 12 over a shelf life of a keg body formed of a single layer of polymer material due to the multiple layers of material limiting an ingress of oxygen and the egress of nitrogen or CO₂. Alternatively or additionally, the keg body 12 may be lined internally with an inert material and/or internally coated with an inert coating to serve as a barrier to permeation by oxygen, nitrogen, and CO₂.

The keg body 12 may be configured to store a fluid under a pressure over a range of pressures. An example range of pressures at which the keg body 12 may be configured to maintain a fluid may be between about 0.25 bar or less and about 10.00 bar or more. In some cases, the keg body 12 may be configured to maintain a fluid contained therein at a pressure below about 4.50 bar, below about 6.00 bar, below about 7.00 bar and/or other pressure. In one example, the keg body 12 may be configured to maintain a fluid contained therein at a pressure between about 0.50 bar and about 3.50 bar.

The base 18 may be a keg bottom chime, but this is not required. In some cases, the base 18 may be adapted to engage the lower part 22C of the keg body 12, for example, by snapping onto the domed lower part 22C or coupling to the lower part 22C in other suitable manners. In one coupling example, the base 18 and the lower part 22C may be in an inter-fitting relationship with one another. In some cases, the base 18 may be integrally formed with the keg body 12.

In some cases, the base 18 may be configured to cooperate with a handle assembly (e.g., the handle assembly 20, shown in FIGS. 1A and 1B) of another keg assembly and allow for stacking of the keg assemblies. For example, when a first side of the base 18 is engaging the lower part 22C of the keg body 12, a second side (e.g., a side opposite of the first side, a side wall, and/or other side) of the keg body 12 may be configured to engage the handle assembly or other portion of a second keg to facilitate stacking kegs.

The base 18 may be comprised of any suitable material. In some cases, the base 18 may be formed from a rubber, a high-density polyethylene (HDPE), a plastic, a metal, and/or one or more other suitable materials. Alternatively or in addition, the base 18 may be comprised of the same materials as the keg body 12 (e.g., plastic, PET, metal, etc.) and/or manufactured in the same manner as the keg body 12 (e.g., blow molded, stretch blow molded, molded, etc.).

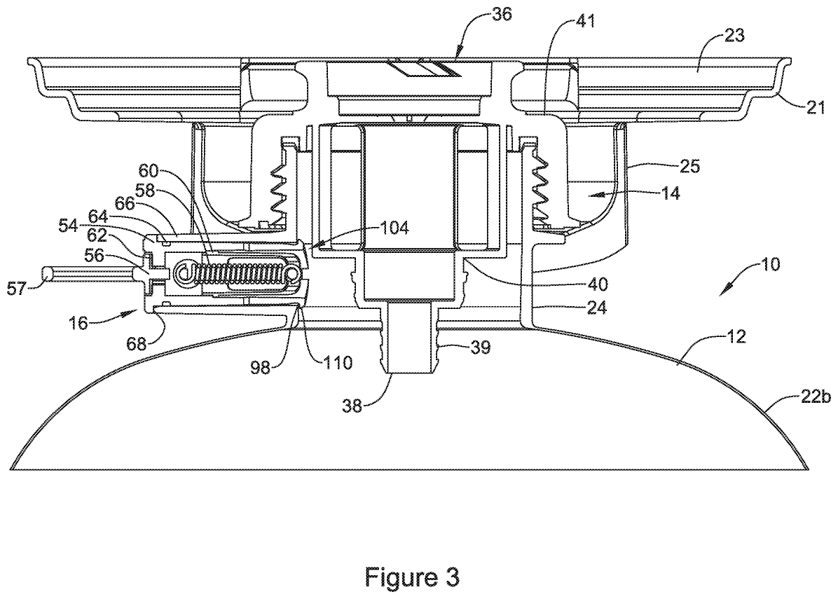

FIG. 3 depicts a schematic cross-sectional view of a top portion of the keg assembly 10. In some cases, for example as depicted in FIG. 3, the top portion of the keg assembly 10 may include the handle assembly 20, the neck assembly 14, the valve assembly 16, the domed upper part 22B of the keg body 12, and the neck portion 24 of the keg body 12.

According to various configurations of the keg assembly 10, the handle assembly 20 may include handles 21 and a chime 23. In some configurations, the handles 21 may have wide, curved surfaces to facilitate carrying or transporting the keg assembly 10 and/or take on one or more other suitable shapes that facilitate carrying the keg assembly 10.

In some cases, the handle assembly 20 may be integrally formed with the keg body 12. As such, the handle assembly 20 may be comprised of the same materials as the keg body 12 (e.g., plastic, PET, metal, etc.) and manufactured in the same manner as the keg body 12 (e.g., blow molded, stretch blow molded, molded, etc.). In other cases, the handle assembly 20 may be a wholly or at least partially separate entity from the keg body 12 and attached to or coupled to the keg body 12 by a suitable means (e.g., welding, fastening, snap-on coupling, threaded coupling, etc.). Moreover, the handle assembly 20 may be comprised of one or more material(s) that are different than the material(s) forming the keg body 12. In one example, the handle assembly 20 may be at least partially formed of metal materials (e.g., stainless steel, aluminum, etc.) even though the keg may be formed of a polymer.

In some cases, the chime 23 may be shaped to receive and cooperate with the base 18 of a similarly shaped keg assembly in such a way that one keg assembly can be stacked on another. The chime 23 may be configured to receive and/or support the base 18 of another keg assembly positioned above the chime 23. In some cases, the chime 23 may have a generally concave upper surface profile which may help align the keg assemblies for stacking. In some cases the handles 21 and the chime 23 may be integrally connected to each other at or adjacent the neck portion 24 of the keg body 12 by supporting elements 25, which may be designed to provide a required strength for carrying a weight of one or more keg assemblies stacked on top of the handle assembly 20.

In some cases, the neck assembly 14 may include and/or receive a dispenser valve, which may be used to fill the keg body 12 with fluid and/or dispense fluid from the keg body 12. FIG. 3 depicts a portion of an illustrative dispenser valve assembly 36, which is schematically depicted, including a dispenser tube engagement portion 38 and a valve body 40. Although the valve body 40 of the dispenser valve assembly 36 is depicted as being formed with a cap 41 configured to engage the neck portion 24 of the keg assembly 10, the cap 41 may be separate from the valve body 40.

The valve body 40 of the neck assembly 14 may include the dispenser tube engagement portion 38 that is configured to engage a dispenser tube (not shown) and disposed within the interior of the keg body 12 to facilitate filling the keg body 12 with fluid and/or removing pressurized fluid from the keg body 12. In one example, the dispenser tube engagement portion 38 may have ridges 39 (e.g., in some cases the ridges 39 may be threads, but this is not required) that are configured to form a friction fit with a dispenser tube received thereon. Additional or alternative suitable engagements between the dispenser tube engagement portion 38 and a dispenser tube may be utilized, as desired. Alternatively or in addition, the valve body 40 or other portion of the neck assembly 14 may form a dispenser tube.

As shown in FIG. 3, the dispenser valve 36 may be inserted into the keg body 12 by disposing the valve body 40 into an opening of the neck portion 24 and positioning the valve body 40 inside the keg body 12. The neck assembly 14 may then be coupled and secured to the neck portion 24 of the keg body 12 by any suitable connection mechanism (e.g., via the cap 41 or other portion of the neck assembly 14) including a threaded coupling mechanism, a snap-on coupling, hooks, screws, pins, clasps, buckles or another suitable type of fastener. In some cases, the neck assembly 14 may threadedly engage interior or exterior (as shown in FIG. 3) threads on the neck portion 24 of the keg body 12 to couple the neck assembly 14 to the keg body 12.

The top portion of the keg assembly 10 may include a valve assembly 16 in the neck portion 24 of the keg body 12. In some cases, the neck assembly 14 may include an extension 66 in communication with a lumen 104 of the neck portion 24 (e.g., where the lumen 104 may be in communication with the hollow interior of the keg body 12) and configured to receive the valve assembly 16. In this example, the hollow extension 66 may extend outward (e.g., radially outward or outward in a different direction) from a side portion of the outer surface of the neck portion 24. However, in other examples, the extension 66 may be located somewhere else along the neck portion 24 and the valve assembly 16 may be placed at that location, accordingly. Alternatively, the extension 66 may be omitted and/or the valve assembly 16 may be located at a different portion of the keg assembly 10. For example, the valve assembly 16 may be located at an elevated location along the side of the neck assembly 14 or located at the top of the neck assembly 14.

In some cases, positioning the valve assembly 16 in communication with the lumen 104 of the neck portion 24 of the keg body 12 may facilitate relieving pressure within the keg body during any stage of a life cycle of the keg assembly 10 due to direct access to an interior of the keg body 12. For example, positioning the valve assembly 16 such that it is in direct communication with the lumen 104 may facilitate and/or allow for relieving pressure in the keg body 12 when the keg body 12 is delivered from a factory before filling, during a brewery fill stage of the keg body 12 and/or while connected to a pressure system, during shipment and/or storage of the at least partially filled keg body 12, while the keg body 12 is in communication with to a dispensing tap system, and/or at one or more other suitable times during the life cycle of the keg assembly 10.

It is contemplated that the valve assembly 16 may be employed to relieve pressure in the keg assembly 10 when pressures inside the keg body 12 reaches and/or goes beyond a threshold value (e.g., a threshold value may be 3.00 bar, 3.50 bar, 4.00 bar, 4.50 bar, 5.00 bar, 5.50 bar, 6.00 bar, 6.50 bar, 7.00 bar, 7.50 bar, or other value) and/or at other suitable times. In one example, the threshold value may be set at a value in a range from 4.50 bar to 7.00 bar.

As shown in FIG. 3, the valve assembly 16 may include a housing 54, a pin 56, a pull 57, a spring 58, a retainer 60, a sealing member 62, and a gasket 64. In various instances, the valve assembly 16 may be disposed within the hollow extension 66 and coupled to the neck assembly 14 by any suitable means including a threaded coupling mechanism, a snap-on coupling, hooks, screws, pins, clasps, buckles, or other similar or dissimilar suitable coupling technique. For example, in the case depicted in FIG. 3, the housing 54 may have a foot 110 that locks the valve assembly 16 to the neck assembly 14 with a snap coupling. When the valve assembly 16 is secured in the extension 66, the gasket 64 may form a seal between the valve assembly 16 and the extension 66 to prevent fluid from flowing between an inner surface of the extension 66 and the outer surface of the housing 54. In such cases, the gasket 64 may be an o-ring or have a different seal forming configuration and may be disposed on an outer surface of the housing 54 (e.g., in an indent or groove 68 along the outer surface of the housing 54).

With seals formed at fluid exits of the keg assembly 10, the keg assembly 10 may experience an increased pressure inside the keg body 12. For example, the pressure from a fluid (e.g., beer, soda, air, nitrogen, CO₂, etc.) inside the keg body 12 may rise above 4.50 bar or go beyond a different suitable threshold. Furthermore, the gas may rise into the lumen 104 of the neck portion 24 and push against the valve assembly 16. Because of the locking of the feet 110 relative to the neck portion 24 of the keg assembly 10, the housing 54 may be firmly secured to the keg body 12. However, the force from the gas may be great enough on the pin 56 to extend the spring 58 from its first axially extended state to its second axially extended state and translate the pin 56 outward into the opened position relative to the inner lumen 70 of the housing 54. In the opened position, an opening in the inner lumen 70 of the housing 54 may be exposed and allow some of the fluid within the keg assembly 10 to move from the lumen 104 of the neck assembly 14, through the inner lumen 70 of the housing 54, and escape out of the opening of the housing 54.

As fluid exits the keg assembly 10 through the opened valve assembly 16, the pressure inside the keg body 12 may begin to decrease. As the pressure decreases the spring 58 may begin to compress (e.g., adjust from its second extended state to its first extended state). As such, the second end 84 of the spring 58 may pull against the second end 82 of the retainer 60 and the first end 96 of the spring 58 may pull against the elongate portion 90 of the pin 56. Accordingly, the spring 58 may apply enough axial force to the elongate portion 90 of the pin 56 to translate the pin 56 into a closed position. Once again, in the closed position, the sealing member 62 may be configured to engage the housing 54 and prevent fluid from flowing out of the inner lumen 70 of the housing 54. This is just one example of how the valve assembly 16 may be configured to operate as an automatic pressure relief valve.

In some cases, the valve assembly 16 may be removable from the vessel wall and, if desired, can be saved for later reuse in other keg assemblies 10. Alternatively, the valve assembly 16 may not be configured to be removed from the keg assembly 10.

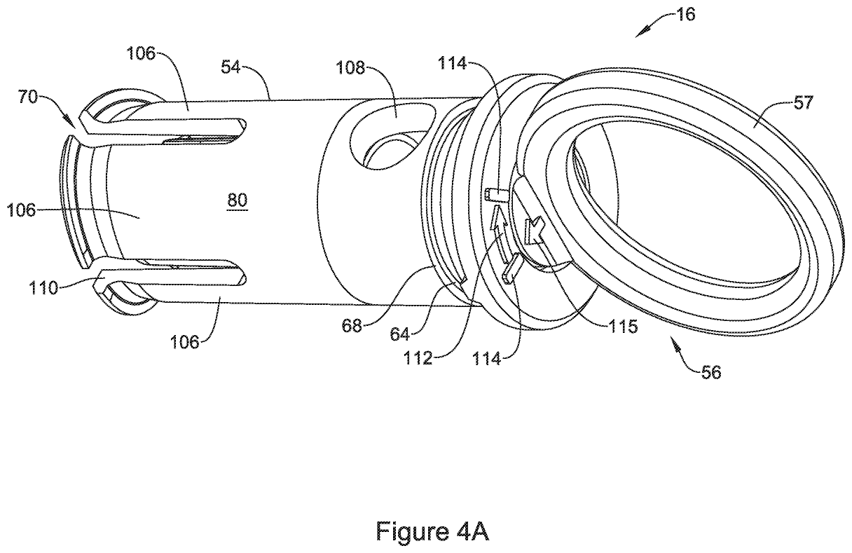

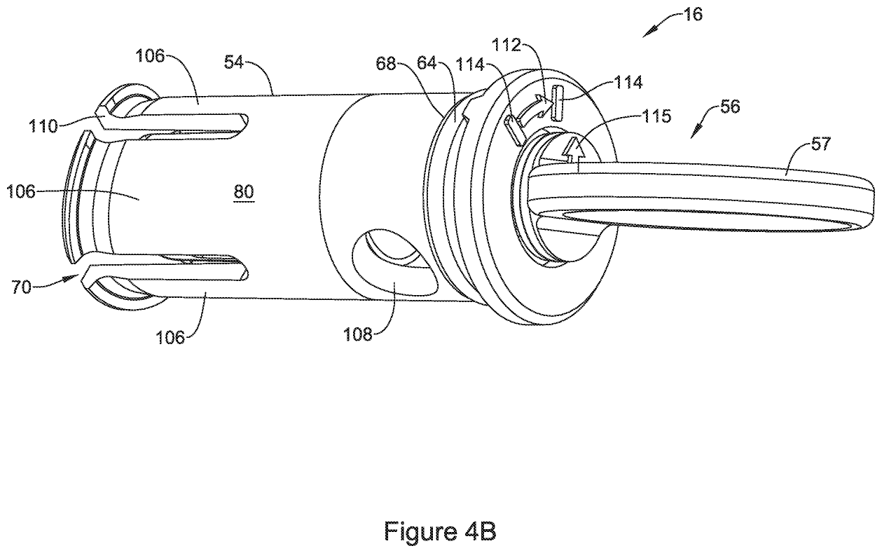

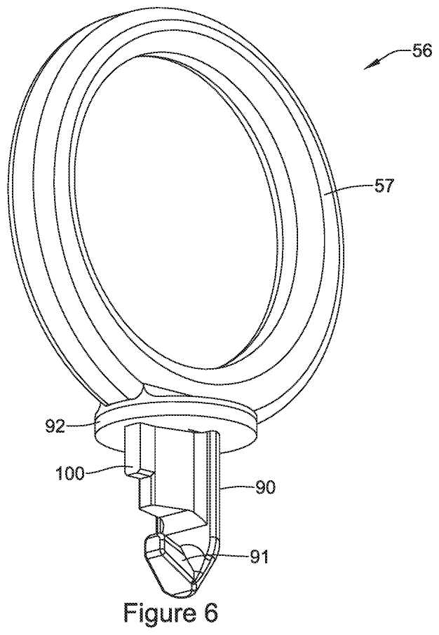

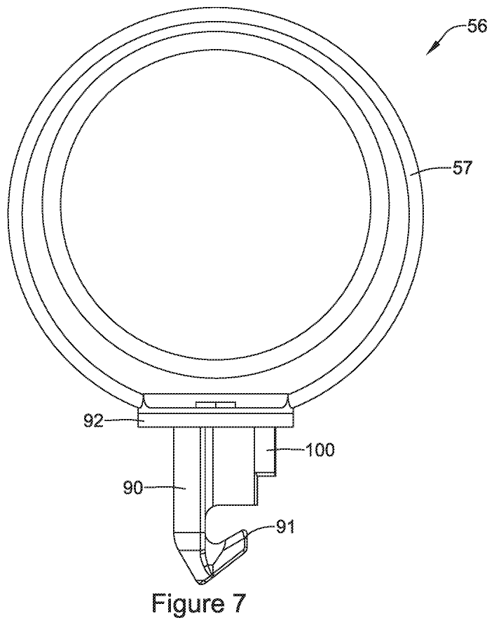

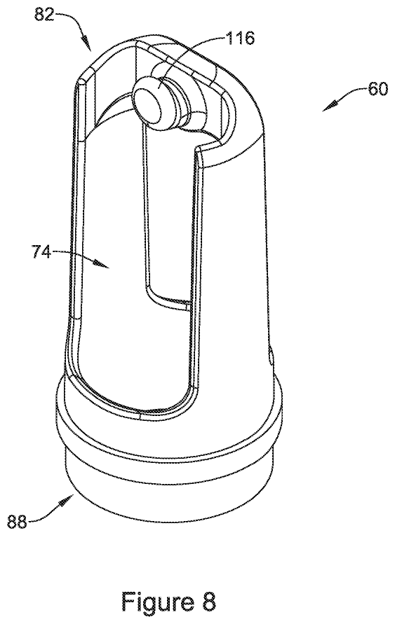

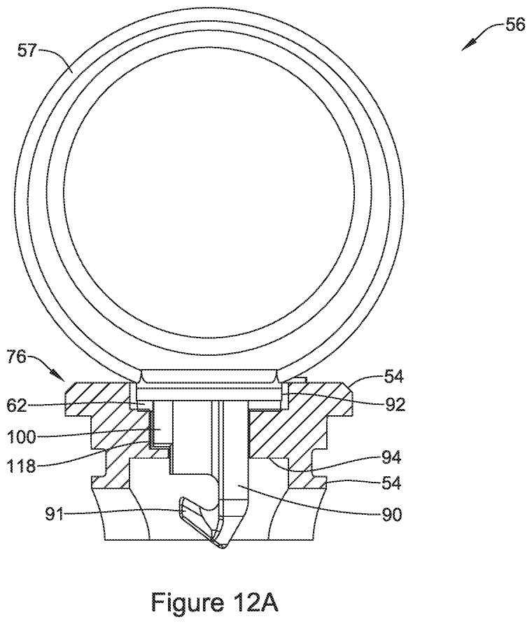

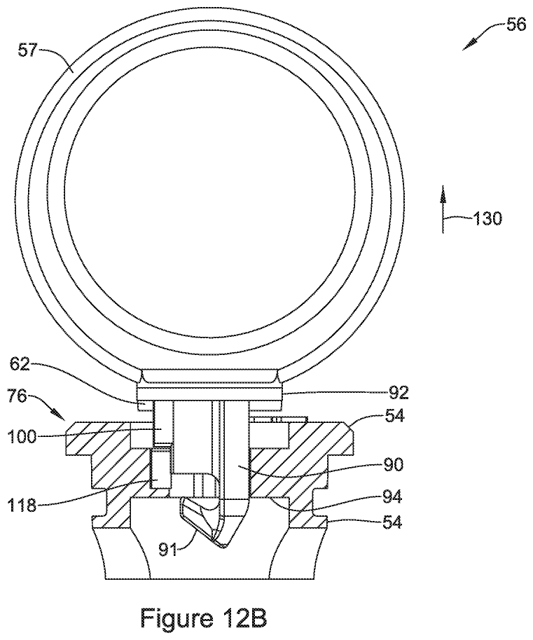

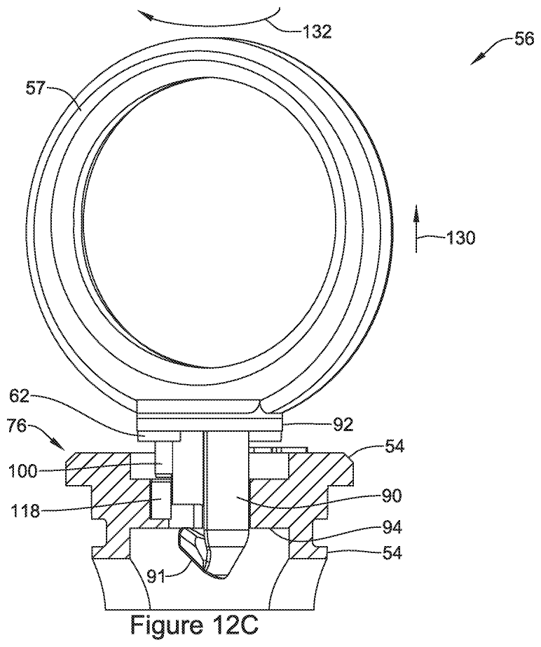

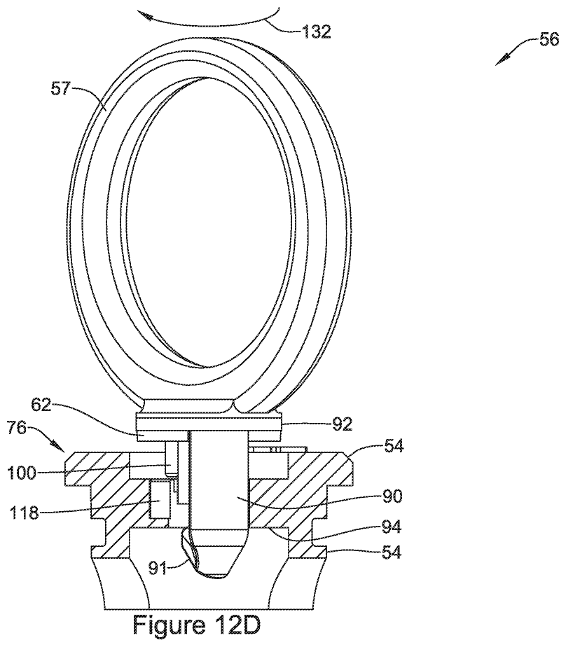

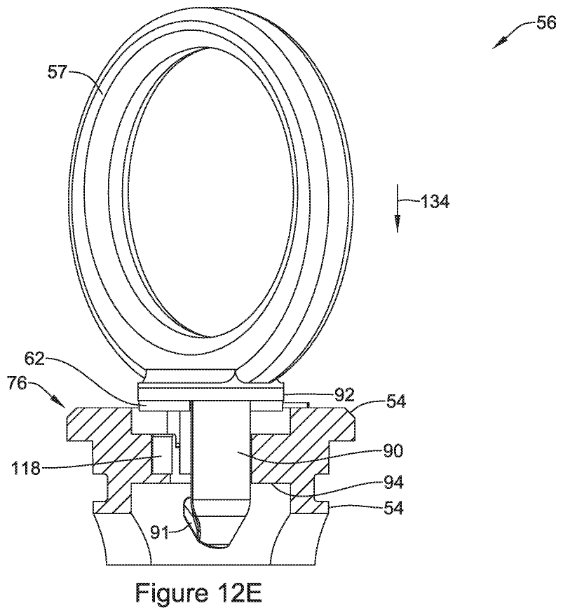

FIGS. 4-12E depict various views of the valve assembly 16 and components thereof. For example, FIGS. 4A-5, 9-11 depict views of the valve assembly 16, FIGS. 6 and 7 depict views of the pin 56, FIG. 8 depicts a view of the retainer 60, and FIGS. 12A-12E depict illustrative steps of manually opening the valve assembly 16.

FIGS. 4A and 4B depict perspective views of the valve assembly 16.

FIG. 4A depicts a perspective view of the valve assembly 16 with the pin 56 in a closed position. FIG. 4B depicts a perspective view of the valve assembly with the pin 56 manually adjusted to an opened position.

As shown in FIGS. 4A and 4B, the valve assembly 16 may include the housing 54 having an outer surface 80, the inner lumen 70, the groove 68 on the outer surface 80, a bore 108 extending from the outer surface 80 to the inner lumen 70, and adjustable members 106 that may facilitate creating a snap coupling between the valve assembly 16 and the neck portion 24 of the keg assembly 10. In some instances, the housing 54 may have one or more indicia (e.g., an arrow 112, position indicators 114, etc.) indicating a direction to turn the pin 56 to open the valve assembly 16 and/or providing other information. Further, although not required, the pin 56 may include indicia (e.g., a position arrow 115 and/or other suitable indicia) indicating a position of the pin 56 and/or providing other information.

In some cases, the outer surface 80 may take on one or more different configurations that facilitates positioning the housing 54 within the neck assembly 14. In one example, the housing 54 may have a diameter that varies along the outer surface 80. In the example and/or a different example, the adjustable members 106 may be flexible to allow the housing 54 to slide within the hollow extension 66 and create a snap fit or coupling with a shoulder 98 (see e.g., FIG. 3 depicting a connection between the shoulder 98 and the feet 110) and couple the valve assembly 16 (e.g., couple the housing 54 of the valve assembly 16) to the neck assembly 14.

The bore 108 may be utilized for various purposes. In some cases, the bore 108 may facilitate a manufacturer and/or operator coupling the spring 58 to the pin 56 when the spring 58 is inside the inner lumen 70 of the housing 54. Alternatively or in addition, the bore 108 may be utilized for viewing the components within the lumen 70 and/or for one or more other purposes.

The housing 54 may be formed from a suitable material. In some instances, the housing 54 may be formed from one or more materials including, but not limited to, rubber, plastic, and/or a lubricious polymer (e.g., a fluorocarbon such as a polytetrafluoroethylene (PTFE)), a polyamide (e.g., nylon), a polyolefin, a polyimide, or the like). Additional polymeric materials which may be used to form the housing 54 may include polyethylene, polyvinyl chloride (PVC), ethyl vinyl acetate (EVA), polyethylene terephthalate (PET), and their mixtures and copolymers. Another useful class of polymers is thermoplastic elastomers, including those containing polyesters as components. For example, the housing 54 may be formed by extruding a rigid thermoplastic elastomer polymer. Other suitable polymers and non-polymer materials may be utilized to form the housing 54, as desired.

As seen in FIGS. 4A and 4B, the pull 57 may be a part of and/or in communication with the pin 56. The pull 57 may be formed with the pin 56, but this is not required, and the pull 57 may be connected to the pin 56 in any suitable manner that facilitates manually adjusting a position of the pin 56 in response to movement of the pull 57 with a user's hand and/or with a tool.

The pull 57 may take on any suitable configuration that facilitates adjusting the pin 56 between a closed position (e.g., as depicted in FIG. 4A) and an opened position (e.g., as depicted in FIG. 4B). Example pull configurations may include, but are not limited to, a ring configuration (e.g., as shown in FIGS. 4A and 4B), a grip configuration, and/or other suitable configurations for pulling or otherwise adjusting the pin 56.

As an alternative to or in addition to the pull 57, the pin 56 may include one or more other features configured to facilitate manual adjustment of the pin 56 between opened and closed positions. In one example, the pin 56 may include one or more slots configured to receive a tool (e.g., a screwdriver, a coin, and/or other suitable tool) and/or may include one or more other suitable features that facilitate manual adjustment of the pin 56.

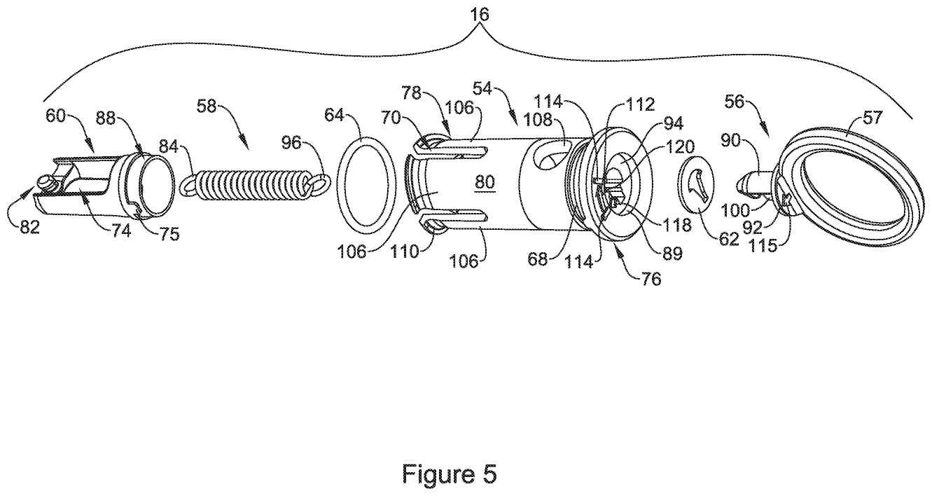

FIG. 5 depicts an exploded view of the valve assembly 16 showing an illustrative assembly of the housing 54, the pin 56, the spring 58, the retainer 60, the sealing member 62, and the gasket 64. For assembly, the spring 58 may be disposed within an inner opening 74 of the retainer 60 (e.g., through a first end 88 of the retainer 60 or other portion of the retainer 60) and the retainer 60 may be disposed in the inner lumen 70 of the housing 54. The sealing member 62 may be disposed on a ledge in the housing 54 (e.g., a ledge of protrusion 94) and the pin 56 may be inserted into the inner lumen 70 of the housing 54, through the disposed sealing member 62, and may engage a first end 76 (e.g., a proximal end) of the housing 54. Furthermore, as described above, the gasket 64 may be disposed on the outer surface 80 of the housing 54 (e.g., in the groove 68).

The housing 54 may take on a configuration as discussed above with respect to FIGS. 3, 4A, and 4B, and/or other suitable configurations. Further, as depicted in FIG. 5, the housing 54 may have the first end 76 and a second end 78, with the lumen 70 extending from the first end 76 to the second end 78 of the housing 54. Alternatively, the lumen 70 may extend only partially between the first end 76 and the second end 78 of the housing 54.

The housing 54 may include features configured to engage the pin 56 and facilitate manually adjusting the pin 56 between a closed position and an opened position and/or maintaining the pin 56 in an opened position and/or closed position. Example features facilitating manually adjusting the pin 56 to an opened and/or a closed position may include, but are not limited to, extensions, grooves, cam surfaces, and/or other suitable features. In one example, the protrusion 94 of the housing 54 may include a first fixed keyed feature 118 for receiving an adjustable keyed feature 100 of the pin 56 when the pin 56 is in a closed position and a second fixed keyed feature 120 for receiving the adjustable keyed feature 100 of the pin 56 when the pin 56 is in an opened position. The adjustable keyed feature 100 may be a male feature (e.g., an extension) or a female feature (e.g., a groove) configured to engage the first fixed keyed feature 118 and the second fixed keyed feature 120, where the first fixed keyed feature 118 and the second fixed keyed feature 120 are the other of a male feature and a female feature configured to engage the adjustable keyed feature 100. In the example depicted in the Figures, the adjustable keyed feature 100 of the pin 56 may be a male feature (e.g., an extension) and the first fixed keyed feature 118 and the second fixed keyed feature 120 may be female features (e.g., grooves).

The second fixed keyed feature 120 may be a predetermined rotational distance from the first fixed keyed feature 118. For example, the predetermined rotational distance may be in a range of one (1) degree or less to three-hundred fifty-nine (359) degrees or more, ten (10) degrees to one-hundred eighty (180) degrees, twenty (20) degrees to ninety (90) degrees, thirty (30) degrees to sixty (60) degrees, and/or in other suitable ranges. In one example, the predetermined rotational distance may be or may be about fifty (50) degrees, as depicted in FIGS. 4A-5. In some cases, the housing 54 may be configured to engage the pin 56 to prevent or limit movement of the pin 56 a rotational distance greater than the predetermined rotational distance, but this is not required.

Although the adjustable keyed feature 100 is labeled and described herein as being adjustable in a longitudinal direction and/or in a rotational direction, it is contemplated that the adjustable keyed feature 100 may be adjustable in one or more other suitable manners and/or may be fixed relative to one or more features of the keg assembly 10. Similarly, although the first fixed keyed feature 118 and the second keyed feature 120 are labeled and described herein as being fixed relative to one or more features of the keg assembly 10, it is contemplated that the first fixed keyed feature 118 and/or the second keyed feature 120 may be fixed relative to one or more other suitable features of the keg assembly 10 than what is described herein and/or may be adjustable relative to one another and/or one or more features of the keg assembly 10.

The pin 56 may have a suitable configuration for being received within the housing 54 of the valve assembly 16. In some cases, the pin 56 may include an elongate portion 90 and a head 92. The elongate portion 90 of the pin 56 may be configured to extend within the lumen 70 and the head 92 may be configured to engage a surface of the housing 54. In some cases, the head 92 of the pin 56 may engage the sealing member 62 to form a seal between the pin 56 and the housing 54. One or more slots 72 may be located in the head 92 or other portion of the pin 56 to facilitate moving (e.g., rotating) the pin 56 relative to the housing 54.

FIGS. 6 and 7 depict the pin 56, where FIG. 6 depicts a bottom perspective view of the pin 56 and FIG. 7 depicts a side view of the pin 56. As shown, the pin 56 may include the elongate portion 90, a hook 91, the head 92, the pull 57, the adjustable keyed feature 100 (e.g., an extension of the pin, as shown in the Figures, a groove, or other suitable feature), and/or one or more other suitable features. Similar to other features of the valve assembly 16, the pin 56 may take on one or more different configurations that facilitate the pin 56 engaging the housing 54 and/or the spring 58. For example, an end of the elongate portion 90 of the pin 56 is shown in FIGS. 6 and 7 as having a coupling configuration (e.g., the hook 91). However, the end of the elongate portion 90 may take on other configurations that facilitate engagement with the spring 58. Further, the pin 56 may be comprised of materials discussed herein with respect to the other components of the valve assembly 16.

Returning to FIG. 5, the spring 58 may be any suitable type of spring (e.g., an extension spring, a compression spring, and/or other suitable type of spring) capable of being configured to extend as the valve assembly 16 adjusts from a closed orientation to an opened orientation and/or compress as the valve assembly 16 adjusts from the opened orientation to the closed orientation. In one example, the spring 58 may be configured within the valve assembly 16 such that it extends (e.g., longitudinally and/or axially expands or otherwise extends) from a first configuration with the valve assembly 16 in a closed orientation to a second configuration with the valve assembly in an opened orientation. The spring 58 may have a first end 96 (e.g., a proximal end) configured to engage the pin 56 and a second end 84 (e.g., a distal end) configured to engage the retainer 60 to facilitate extending the spring 58 as the valve assembly 16 adjusts from a closed orientation to an opened orientation.

The spring 58 may take on various configurations that allow the spring 58 to engage the pin 56, the retainer 60, the housing 54 and/or other components of the valve assembly 16. For example, the first end 96 and the second end 84 of the spring 58 are depicted as having or forming a hook or loop. However, the first end 96 and/or the second end 84 may take on other configurations that facilitate engagement with the pin 56, the retainer 60, the housing 54, and/or other components of the valve assembly 16.

According to various configurations, the spring 58 may include one or more materials. For example, the spring 58 may include, among other materials, brass, stainless steel (e.g., high tensile stainless steel) and/or other materials, including but not limited to polymers, metals, and metal alloys, such as tungsten, gold, titanium, silver, copper, platinum, palladium, iridium, ELGILOY nickel-cobalt alloys, cobalt chrome alloys, molybdenum tungsten alloys, tantalum alloys, titanium alloys, nickel-titanium alloys (e.g., nitinol), etc.

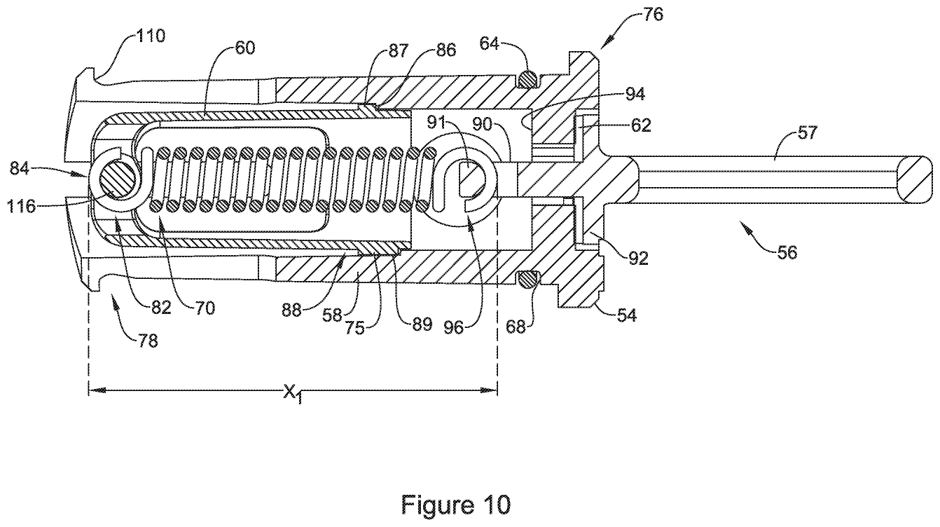

The retainer 60 may have a suitable configuration for engaging the housing 54 and the spring 58. In some cases, the retainer 60 may include a first end 88 (e.g., a proximal end) and a second end 82 (e.g., a distal end) with the opening 74 through the retainer 60 extending from the first end 88 to the second end 82 of the retainer 60. Alternatively, the opening 74 may extend only partially between the first end 88 and the second end 82 of the retainer 60. Further, the retainer 60 may include a locator 75 formed on or connected to a side of the retainer such that it is configured to mate with a notch on the housing 54 (e.g., see FIG. 10).

FIG. 8 depicts a perspective view of the retainer 60. The retainer 60 may take on various configurations that facilitate the retainer 60 engaging the housing 54, the spring 58, and/or other components of the valve assembly 16. For example, the second end 82 of the retainer 60 is shown in FIG. 8 as having the knob 116 to engage the hook or loop configuration of the spring 58. However, the second end 84 may take on other configurations that would facilitate engagement with the spring 58. Furthermore, the retainer 60 may be comprised of the materials similar to those materials discussed herein with respect to other components of the valve assembly 16.

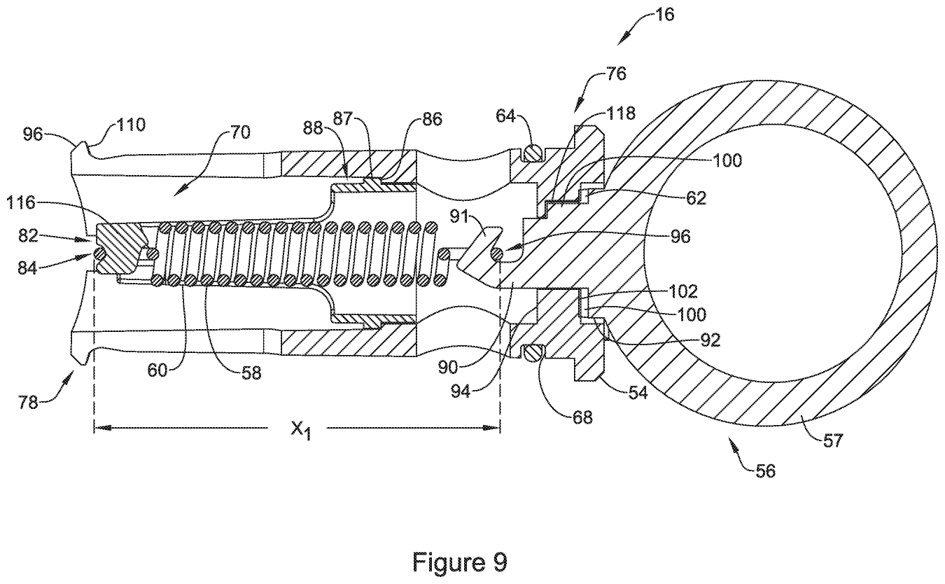

FIGS. 9 and 10 depict cross-sectional views of the valve assembly 16 depicted in FIG. 4A-5, where the cross-section of FIG. 10 is a cross-section taken along a plane that is generally perpendicular to a plane along which the cross-section of FIG. 9 is taken. As discussed above, the lumen 70 of the housing 54 may be configured to receive one or more elements of the valve assembly 16 including, but not limited to the pin 56, the spring 58, the retainer 60, the sealing member 62, and/or one or more other features. The valve assembly 16 depicted in FIGS. 9 and 10 is in a closed configuration, where the spring is in a first position and has a length X₁.

As shown in FIGS. 9 and 10, the inner lumen 70 of the housing 54 may have a relatively constant diameter from the second end 78 of the housing 54 to a step 86 that defines a portion of the inner lumen 70. Such a configuration may facilitate allowing the housing 54 to receive the retainer 60. In one example, the housing 54 may be configured to receive the retainer 60 into the lumen 70 through the second end 78 of the housing 54 and allow the retainer 60 to slide proximally until the retainer 60 abuts the step 86 at a reduced diameter of the lumen 70. In some cases, a ledge 87 of the retainer 60 may be configured to engage the step 86 and limit movement of the retainer 60 toward the first end 76 of the housing 54. The ledge 87, when included, may extend partially or entirely around a circumference of the retainer 60. In some cases, the locator 75 of the retainer 60 may engage a notch 89 in the housing 54 to facilitate aligning the retainer 60 at a desired position relative to the housing 54, but this is not required.

In some cases, the second end 84 of the spring 58 may be configured to engage or couple to the second end 82 of the retainer 60 by a suitable coupling mechanism including, but not limited to, a threaded coupling mechanism, a snap-on coupling, hooks, screws, pins, clasps, buckles or another type of fastener. In the example of FIGS. 9 and 10, the second end 82 of the retainer 60 may be configured with a hook or knob 116 and the second end 84 of the spring 58 may include a coupling feature (e.g., a loop, hook, or other coupling feature) to couple the retainer 60 and the spring 58 to one another. In cases when the valve assembly 16 may not include the retainer 60, the second end 78 of the housing 54 or other feature of the valve assembly 16 may be configured to engage the second end 84 of the spring 58 in a manner similar to and/or different than how the depicted retainer 60 may couple to the spring 58.

The pin 56 may be received in the housing 54 and configured to engage the spring 58. In some cases, the elongate portion 90 of the pin 56 may engage or couple to the first end 96 of the spring 58 by any suitable means including a threaded coupling mechanism, a snap-on coupling, hooks, screws, pins, clasps, buckles or another type of fastener. In the example of FIGS. 9 and 10, the elongate portion 90 and the first end 96 of the spring 58 may both comprise hooks or loops, but this is not required and one or both of the first end 96 of the spring 58 and the elongate portion 90 may be and/or may include other coupling features.

As shown in FIGS. 9 and 10, the first end 76 of the housing 54 may have a protrusion 94 at least partially defining the inner lumen 70 of the housing 54. When the pin 56 is inserted into the inner lumen 70, the elongate portion 90 of the pin 56 may be configured to extend through a portion of the lumen 70 defined by the protrusion 94 and the head 92 of the pin 56 may engage a surface of the protrusion 94. In some cases, the valve assembly 16 may include the sealing member 62 and when the pin 56 is inserted into the lumen 70 and engaging the spring 58, the head 92 of the pin 56 may engage the sealing member 62 and/or the surface of the protrusion 94.

Further, in the example depicted in the Figures, the adjustable keyed feature 100 of the pin 56 may extend into the first fixed keyed feature 118 of the housing 54 when the pin 56 is inserted into the inner lumen 70 to facilitate maintaining the pin 56 in a closed position and facilitate longitudinal movement of, and without or with limited rotation of, the pin 56 in response to pressures inside the keg body 12. The engagement or relationship of the adjustable keyed feature 100 and the first fixed keyed feature 18 may prevent or limit rotational movement of the pin 56 while the adjustable keyed feature 100 and the first fixed keyed feature 118 are engaged.

When the first end 96 of the spring 58 is engaging the pin 56 and the second end of the spring 84 is engaging the retainer 60 or other portion of the valve assembly 16, the spring 58 may be in the first position and apply a pulling force on the pin 56 to close the valve assembly 16, such that the spring 58 has the first length X₁. The valve assembly 16 may be biased in the closed configuration by the spring 58.

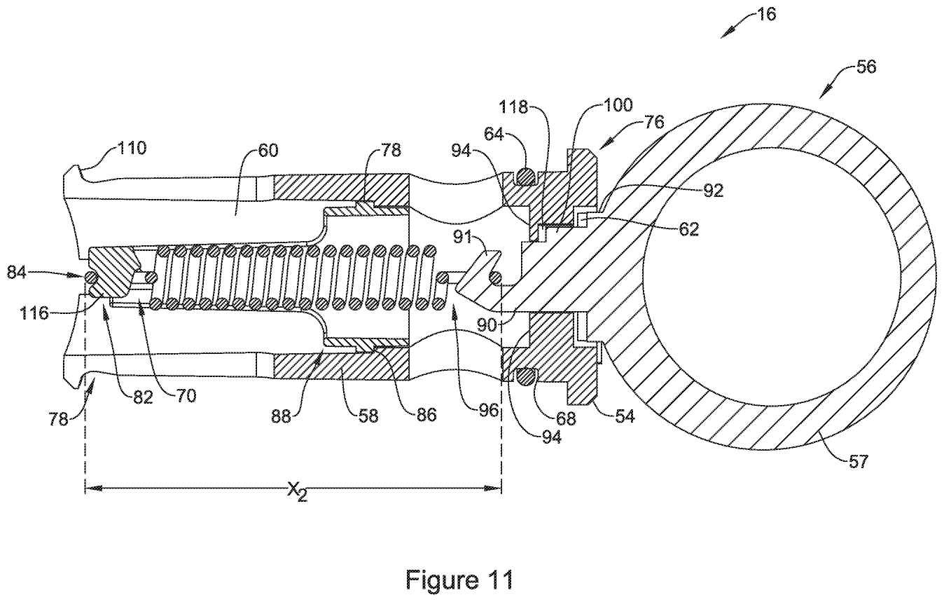

FIG. 11 depicts the valve assembly 16 of FIGS. 9 and 10 in an opened configuration with a space between the pin 56 and the housing 54 due to pressures within the housing 54, from the cross-sectional plane view depicted in FIG. 9. When positioned in the opened configuration, the pin 56 may slide within the housing 54 such that the adjustable keyed feature 100 is maintained within the first fixed keyed feature 118 and the spring 58 may be extended to a second position such that it has a length X₂, there the length X₂ is greater than the length X₁. Further, adjusting the valve assembly 16 to the opened configuration and extending the spring 58 to the second position, may require a force working against a spring constant or bias force of the spring 58. As such, when the valve assembly 16 is in the opened configuration, the spring 58 may be biasing the valve assembly 16 to the closed position.

In some cases, when the pin 56 is in the closed position, as shown in FIGS. 9 and 10, the spring 58 may be in a first axially extended state as opposed to its natural equilibrium state. The spring 58 may be in its extended state because the second end 82 of the retainer 60 may pull on the second end 84 of the spring 58 in a first direction and the elongate portion 90 of the pin 56 may pull on the first end 96 of the spring 58 in a second, opposite, direction. As such, the spring 58 may naturally pull back on the second end 82 of the retainer 60 and the elongate portion 90 of the pin 56 and bias the pin 56 inward and maintain the valve assembly 16 in the closed configuration until a pressure within the valve assembly 16 reaches or goes beyond a threshold level of pressure and/or an operator applies a force on the pin 56 (e.g., on the pull 57 as discussed below with respect to FIGS. 12A-12E) and adjusts a position of 56 relative to the housing 54 to place the pin 56 in an opened position and extend the spring 58 to a second extended configuration have a second length greater than a first length of the first extended configuration.

The engagement between the pin 56 and the housing 54 may be any suitable type of engagement. In one example, the engagement between the pin 56 and the first end 76 of the housing 54 may be a threaded engagement, a keyed engagement, or any other kind of adjustable engagement. Alternatively or in addition, the first end 76 of the housing 54 may have a locking mechanism that locks the pin 56 relative to the housing 54 when the pin 56 is rotated to the closed positon and/or the opened position. Such a locking mechanism may be formed by engagement of the adjustable keyed feature 100 of the pin 56 in the first and second fixed keyed features 118 and 120, but other configurations are contemplated. In this configuration, to manually open the valve assembly 16 a user may apply a force on the pull 57, longitudinally adjust the pin 56 a predetermined distance in response to the applied force such that the adjustable keyed feature 100 may be clear of the first fixed keyed feature 118, rotate the pin 56 to a predetermined angle, and release the pull 57 to allow the spring to longitudinally adjust the pin 56 to a fixed or locked, manually opened position such that the adjustable keyed feature 100 may be positioned within the second fixed keyed feature 120.

Alternatively or in addition, an engagement between the pin 56 and the housing 54 may be a cam engagement such that the pin 56 has a cam surface (e.g., a first cam surface) configured to slidingly engage a cam surface (e.g., a second cam surface) of the housing 54. In such a configuration, an operator may insert a tool (e.g., a screwdriver, a coin, a knife, fingers, etc.) into a slot on the head 92, engage the pull 57, or engage the pin 56 in other suitable manners, to rotate the pin 56 from exterior of the valve assembly 16. As the pin 56 rotates, the cam surface of the pin 56 may engage the cam surface of the housing 54 to lift the pin 56 outward with respect to the lumen 70 of the housing 54, extend the spring 58, and open the valve assembly 16. In some cases, the manually adjusted pin 56 may rest on a resting surface of the housing 54 to maintain the valve assembly 16 in an opened configuration.

One example of an operator manually rotating the pin 56 from a closed position to an opened position is depicted in FIGS. 12A-12E. Although FIGS. 12A-12E depict an example of an operator rotating the pin 56, the pin 56 may be rotated in one or more other suitable manners. For clarity purposes, FIGS. 12A-12E depict only the housing 54 (in cross-section), the pin 56, and the sealing member 62 of the valve assembly 16, but it should be understood that a compression force may be acting on the hook 91 of the pin 56 to bias the pin 56 into engagement with the housing 54.

FIG. 12A depicts the pin 56 engaging the housing 54 prior to any opening force acting on the pin 56, such that the valve assembly 16 is in a closed configuration with the adjustable keyed feature 100 engaging the first fixed keyed feature 118. FIG. 12B depicts a force from a user or a tool in the direction of arrow 130 engaging the pin 56 (e.g., engaging the pull 57 or other suitable portion of the pin 56) to move the pin 56 and the hook 91 longitudinally a predetermined distance in the direction of the arrow 130 such that the adjustable keyed feature 100 disengages or clears the first fixed keyed feature 118 and is able to rotate and the valve assembly 16 is in a opened configuration such that fluid may be released from within the housing 54 (e.g., from within the keg body 12 or other assembly within which the valve assembly 16 is used).

The predetermined distance may be any suitable distance. For example, the predetermined distance may be a distance in a range from one (1) millimeter (mm) or less to twenty (20) mm or more, one (1) mm to ten (10) mm, one (1) to five (5) mm, and/or other suitable range. In one example, the predetermined distance may be or may be about three (3) mm.

FIG. 12C depicts the pin 56 in a partially manually opened position with a rotational force in the direction of arrow 132 being applied to the pin 56 to rotate the pin 56. As depicted in FIG. 12C, the pin 56 has been rotated or rotated about twenty-five (25) degrees relative to a location of the pin 56 when the adjustable keyed feature 100 is engaging the first fixed keyed feature 118. While the pin 56 is in the partially manually opened position, the force in the direction of arrow 130 may be removed from the pin 56 and the adjustable keyed feature 100 may rest on a top surface of the protrusion 94 of the housing 54 during rotation of the pin 56 relative to the housing 54 such that the pin 56 may slide along the housing 54 as the pin 56 is rotated. Alternatively or in addition, the force in the direction of arrow 130 may be maintained while rotating the pin 56 relative to the housing 54 such that the adjustable keyed feature 100 does not rest on the top surface of the protrusion 94 of the housing 54.

FIG. 12D depicts pin 56 in an almost fully manually opened position with the rotational force in the direction of arrow 132 being applied to the pin 56 to rotate the pin 56. As depicted in FIG. 12D, the pin 56 has been rotated or rotated about forty-nine (49) degrees relative to a location of the pin 56 when the adjustable keyed feature 100 is engaging the first fixed keyed feature 118. While the pin 56 is in the almost fully manually opened position, the force in the direction of arrow 130 may be removed from the pin 56 and the adjustable keyed feature 100 may rest on a top surface of the protrusion 94 of the housing 54 during rotation of the pin 56 relative to the housing 54 such that the pin 56 may slide along the housing 54 as the pin 56 is rotated. Alternatively or in addition, the force in the direction of arrow 130 may be maintained while rotating the pin 56 relative to the housing 54 to a fully opened position such that the adjustable keyed feature 100 does not rest on the top surface of the protrusion 94 of the housing 54.

FIG. 12E depicts the pin 56 in a fully manually opened position with the rotational force in the direction of arrow 132 and the longitudinal force in the direction of arrow 130 removed, such that a compression force in direction of arrow 134 acting on the hook 91 of the pin 56 pulls the pin 56 into engagement with the housing 54 such that the valve assembly 16 may be in a fixed or locked manually opened configuration. Although it may not be depicted in FIG. 12E, the adjustable keyed feature 100 of the pin 56 may be engaging the second fixed keyed feature 120 when the pin 56 is in the fully manually opened position and the force in the direction of arrow 130 has been removed or reduced to a level below a force acting on the pin 56 in the direction of the arrow 134. In such cases, the adjustable keyed feature 100 of the pin 56 may rest on a bottom surface of the second keyed feature 120 such that an opening between pin 56 and the housing 54 is maintained to keep the valve assembly 16 in a manually opened configuration. Further, when the adjustable keyed feature 100 is in engagement with the second fixed keyed feature 120, the pin 56 may be considered to be rotationally locked relative to the housing 54 as the second fixed keyed feature 120 may prevent or restrict rotational movement of the pin 56 relative to the housing 54.

To manually close the valve assembly, the steps depicted and described with response to FIGS. 12A-12E may be reversed. Alternatively or in addition, one or more other suitable steps may be incorporated to facilitate manually closing the valve assembly 16.

In some cases, the configuration of the valve assembly 16 may be different from the one described. In some cases, the valve assembly 16 may have more or fewer elements than described and/or have various elements in different configurations, which may or may not provide the same functionality. In one example, it is contemplated the valve assembly 16 may have an adjustment means (e.g., the pin 56) on the second end 78 of the housing 54 in addition to or as an alternative to having an adjustment means on the first end 76 of the housing 54. This type of placement may be useful to prevent tampering by individuals other than designated individuals (e.g., operators) and/or useful for other purposes.

In addition, it is contemplated that some configurations of the valve assembly 16 may be two-way adjustable. In other words, a valve assembly 16 may be adjusted on its first end 76 and/or its second end 78.

Though not necessarily shown, the valve assembly 16 may also include closure means that facilitate locking the valve assembly 16 in place to the neck assembly 14. This feature of the valve assembly 16 could be useful to prevent tampering with or removal of the valve assembly 16. For example, a safety wire could be threaded through the housing 54 and the hollow extension 66, and the closure means can be removed by snipping the wire to allow access to the valve assembly 16. In addition, the safety wire may be crimped or otherwise reinforced. Any suitable closure means, however, could be employed to facilitate safety and secure transport of the valve assembly 16 installed in the keg assembly 10 and to disallow removal or theft of the valve assembly 16.

The above description is intended to be illustrative, and not restrictive. For example, the above-described examples (or one or more aspects thereof) may be used in combination with each other. Also, in the above description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Description as examples or embodiments, with each claim standing on its own as a separate embodiment, and it is contemplated that such embodiments can be combined with each other in various combinations or permutations.

What is claimed is:

1. A pressure relief valve assembly, the valve assembly comprising:
a housing having an inner lumen extending from a first end of the housing to a second end of the housing;
a pin configured to engage the first end of the housing; and
a spring having a first end coupled to the pin, the spring is configured to bias the pin in a closed position relative to the inner lumen of the housing and axially extend when the pin is adjusted from the closed position to an opened position.

2. The valve assembly of claim 1, further comprising:
a sealing member disposed on an outer surface of the pin and configured to engage the housing when the pin is in the closed position.

3. The valve assembly of claim 1, wherein the first end of the housing has a ledge at least partially defining the inner lumen and the pin has an elongate portion configured to mate with the ledge.

4. The valve assembly of claim 1, further comprising:
a retainer disposed within the inner lumen of the housing and engages a second end of the spring.

5. The valve assembly of claim 4, wherein the housing has a step at least partially defining the inner lumen of the housing and the step engages the retainer to limit movement of the retainer toward the first end of the housing.

6. The valve assembly of claim 5, wherein a first end of the retainer engages the step and a second end of the retainer engages the spring.

7. The valve assembly of claim 1, wherein the pin includes a hook configured to engage the first end of the spring.

8. The valve assembly of claim 1, wherein the engagement between the pin and the first end of the housing includes a keyed engagement.

9. The valve assembly of claim 8, wherein the pin is configured to move from the closed position to the opened position in response to rotational movement of the pin.

10. An assembly for a keg, the neck assembly comprising:
a neck having an outer surface extending from a top portion to a bottom portion of the neck and defining a neck lumen; and
a valve assembly disposed in the neck, the valve assembly comprising:
a housing having an inner lumen extending from a first end to a second end of the housing;
a pin configured to couple to the first end of the housing; and
a spring having a first end configured to couple to the pin, the spring is configured to bias the pin in a closed position relative to the inner lumen and axially extend as the pin moves from the closed position to the opened position.

11. The assembly of claim 10, further comprising:
an extension in communication with the neck lumen and extending outward from a portion of the outer surface of the neck; and
wherein the valve assembly is received within the extension.

12. The assembly of claim 11, the valve assembly further comprising:
a gasket configured to be disposed on an outer surface of the housing and provide a seal preventing fluid from flowing between an inner surface of the extension and an outer surface of the valve assembly.

13. The assembly of claim 10, further comprising:
a retainer disposed in the inner lumen of the housing and engaging a second end of the spring; and
wherein the inner lumen of the housing includes a step at least partially defining the inner lumen and engaging the retainer to limit movement of the retainer toward the first end of the housing.

14. The assembly of claim 10, wherein the pin has an adjustable keyed element configured to engage one or more fixed keyed elements of the housing.

15. The assembly of claim 14, wherein the adjustable keyed element is configured to engage a first keyed element when the pin is in the closed position and the adjustable keyed element is configured to engage the second keyed element when the pin is in the opened position.

16. A keg assembly configured to adjust pressure within the keg assembly, the keg assembly comprising:
a keg body having a neck portion and a hollow interior configured to hold the fluid;
a hollow extension in communication with the hollow interior of the keg body; and
a valve assembly configured to be disposed within the hollow extension, the valve assembly comprising:
a housing having an inner lumen extending from a first end to a second end of the housing;
a pin configured to engage the first end of the housing; and
a spring having a first end engaging the pin and a distal end configured to couple to the retainer, the spring is configured to extend upon transitioning the pin from a closed position to an opened position to decrease the pressure inside the keg body.

17. The keg assembly of claim 16, further comprising:
a retainer disposed in the inner lumen of the housing and engaging a second end of the spring; and
wherein the housing includes a step defining the inner lumen and the step limits movement of the retainer toward the first end of the housing such that the spring applies a compression force on the pin to bias the pin in the closed position.

18. The keg assembly of claim 16, wherein the engagement between the pin and the first end of the housing includes a keyed engagement.

19. The keg assembly of claim 16, wherein the pin is configured to adjust from the closed position to the opened position and decrease the pressure within the keg body in response to rotation of the pin and extending the spring.

20. The keg assembly of claim 16, wherein the keg body is comprised of polyethylene terephthalate (PET).
